(19) United States
(12) Patent Application Publication
(10) Pub. No.: US 2009/0182777 A1
(43) Pub. Date: Jul. 16, 2009

(54) Automatically Managing a Storage Infrastructure and Appropriate Storage Infrastructure

(75) Inventors: Christian Bolik, Oldenburg (DE); Nils Haustein, Soergenloch (DE); Elinar Lueck, Weil im Schoenbuch (DE); Dietmar Noll, Bad Soden-Salm (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: Iternational Business Machines Corporation, Armonk, NY (US)

(21) Appl. No.: 12/351,894

(22) Filed: Jan. 12, 2009

(30) Foreign Application Priority Data
Jan. 15, 2008 (DE) 08100484.8

(51) Int. Cl. G06F 17/30; G06Q 10/00; G06Q 50/00

(52) U.S. Cl. 707/104.1; 705/11; 705/10; 707/E17.044

(57) ABSTRACT

With the present invention means are provided for automatically managing a storage infrastructure with a plurality of storage components in compliance with consumer service level objectives (SLOs). Therefore, the claimed method comprises: automated identification of available storage components, which are appropriate for storing consumer data under consideration of specified service level objectives (SLOs); automated mapping of said consumer SLO policies to said available storage components to select available storage components for specified data classes; and automated configuration of said selected storage components according to said mapping of consumer SLO policies.

### BACKGROUND OF THE INVENTION

1. Field of the Invention

In general, the present invention relates to managing a storage infrastructure, which comprises storage components for storing consumer data under consideration of consumer specified SLO policies, which are consumer specified service level objectives for consumer specified data classes. Usually, such a storage infrastructure comprises at least one consumer data interface and at least one provider interface.

2. Description of the Related Art

A storage infrastructure according to prior art is presented in FIG. 1 and explained herein after. The storage infrastructure shown in FIG. 1 is provided and managed by a provider 110 and used by at least one consumer 104. Consumer 104 in this context is a person or organization which stores data 106 under consideration of different service levels 107. Therefore, the storage infrastructure comprises storage components 116. The term storage components here refers to both, storage devices providing capacity and data access, as well as storage software dealing with these devices or the data. Such storage software according to prior may includes functions to virtualize storage infrastructure, management functions, configuration functions, monitoring and reporting functions and alerting function. The data 106 is stored via a consumer data interface 120 in the storage components 116. Besides, the consumer 104 provides service levels 107 for his data to the provider 110, what is manifested in a service level agreement (SLA).

A provider 110 in this context is a person or organization which provides and manages the storage infrastructure and ensures that the service levels 107 are met. Consumer 104 and provider 110 can be one and the same organization or enterprise or they can be of different enterprises. Service levels 107 in this context are measurable properties used to describe the consumer's requirements for the storage of his data 106. For example, one service level may describe the initial access time for data which can be measured in seconds. The storage components 116 selected must fulfill the consumer specified service levels 107.

The management of the storage infrastructure comprises mapping, selecting and configuring storage components 116 according to service levels 107, measuring achievement of service levels 107 and providing corresponding reports 140 as well as acting upon failures to meet service levels 107. Therefore the storage infrastructure comprises a management component 132 and a reporting component 130, which are accessible to the provider 110 via a provider interface 122.

In a storage infrastructure as described above most of these management tasks have to be carried out manually. Especially, the provider 110 has to map the consumer service levels 107 to storage components 116. The provider 110 has to manually configure the storage components 116 based on the service levels 107 via the management component 132. The provider 110 has to ensure that the service levels 107 are met. Therefore, he has to monitor the system and act upon failures to meet service levels 107. The provider 110 also has to generate reports 140 via the reporting component 132 based on consumer service levels 107 and he has to charge the consumer 104 based on these reports 140. Additionally, the provider 110 has to provide the capacity requested by the consumer 104, even though the consumer 104 may not initially require the requested amount. This results in a waste of storage resources. In such consumer-provider model the provider is very dependent on his human resources (manpower) to map, select, provision, configure, monitor, correct and report a storage infrastructure. Besides, this consumer-provider model is prone for mistakes, which can become expensive for the provider. This is particularly important for outsourcing contracts.

There is one component according to prior art—called Data Facility System Managed Storage (DFSMS)—which allows the automated mapping of data to storage components based on predefined policies (also called ACS routines). Such policies are predefined by the user and do not actually reflect the capabilities of the underlying storage infrastructure. However, DFSMS is very limited in the service levels it supports, and it does not allow for automated mapping between service levels and storage components. Additionally, DFSMS does not monitor the achievement of service levels and perform corrective actions.

The present invention provides methods and means to automatically manage a storage infrastructure with a plurality of storage components in compliance with consumer service level objectives (SLOs).

### BRIEF SUMMARY OF THE INVENTION

The foregoing object is achieved by a method and an infrastructure as laid out in the independent claims. Further advantageous embodiments of the present invention are described in the subclaims and are taught in the following description.

According to the present invention the claimed method comprises

automated identification of available storage components, which are appropriate for storing consumer data under consideration of specified service level objectives;

automated mapping of said consumer SLO policies to said available storage components to select available storage components for specified data classes; and

automated configuration of said selected storage components according to said mapping of consumer SLO policies.

Starting from the storage infrastructure described above, the claimed storage infrastructure is characterized by at least one management instance, which automatically ensures that consumer data is stored on appropriate storage components satisfying the corresponding SLO policies;

at least one consumer service level interface for providing SLO policies to said management instance,

a component discovery and classification module (CDC module) for identifying storage components appropriate for storing consumer data according to specified SLOs, and

at least one repository for storing metadata associated with the storing of consumer data under consideration of SLO policies.

Accordingly, the basic features of the present invention relate to:

Automated storage component discovery and classification in terms of SLOs and service levels provided. It should be mentioned here, that in the context of the present invention SLOs may be expressed using different service levels. For instance, the SLO “initial access time” may have different service levels like 5 seconds or 10 minutes. Furthermore the service levels for a particular class of data can change over time. For example e-mail data might have an initial access time service level of <5 second for the first year and <30 seconds for the next years.

Automated mapping of consumer data to storage components according to its SLOs. Usually, the consumer classifies the data to be stored into individual classes of data e.g., said classification may be based on the data's business value. Accordingly, the consumer can define a particular set of SLOs for each data class.

And, automated configuration of storage components according to these SLOs.

Enhanced embodiments of the present invention further comprise the possibilities of:

automatically providing storage capacity according to defined policies,

automatically adjusting storage components based on changing SLOs or SLO breaches, and

automated reporting of storage components status and providing chargeback reports for a given billing period.

The major advantage of the system proposed by the present invention is that it includes components and methods to carry out all these tasks in an automated manner, covering the entire range of storage-related service level requirements. In the following, this system is called OnDemand Storage System (ODSS).

### BRIEF DESCRIPTION OF THE DRAWINGS

The novel features of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a diagram illustrating a storage infrastructure according to prior art;

FIG. 2 shows a diagram illustrating the basic concept of ODSS as an extension of a prior art infrastructure as shown in FIG. 1;

FIG. 3 shows a flowchart illustrating a process to measure SLO policies and handle SLO breaches;

FIG. 4 shows a flowchart illustrating a process for SLO lifecycle management;

FIG. 5 shows a flowchart illustrating a process for just-in-time capacity provisioning;

FIG. 6 shows a flowchart illustrating a process for storage component discovery and classification; and

FIG. 7 shows a flowchart illustrating a process for the mapping of SLO-policies to storage components.

### DETAILED DESCRIPTION OF THE INVENTION

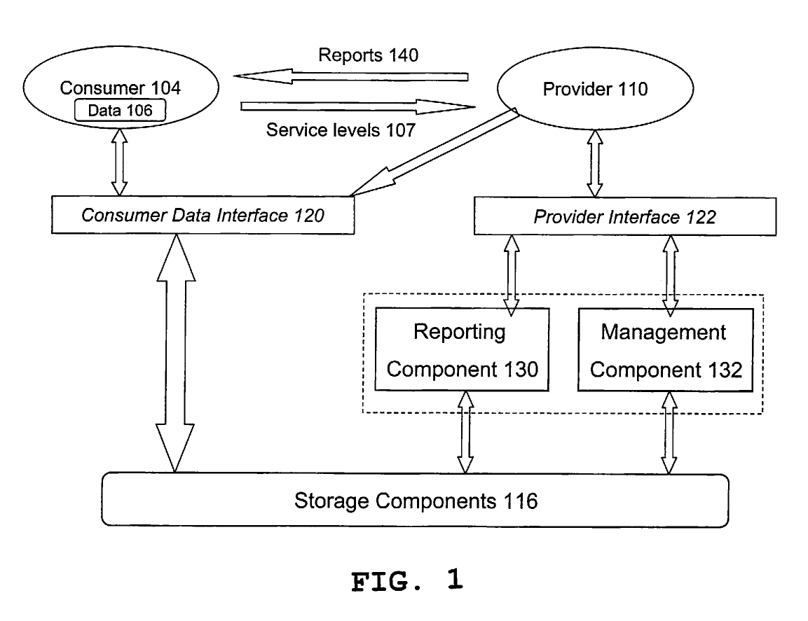

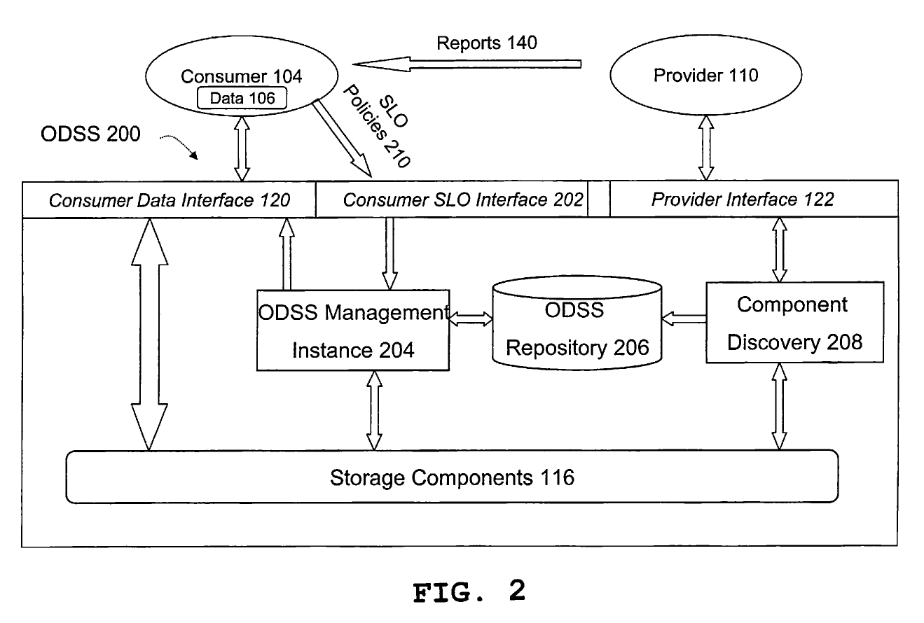

As the storage infrastructure shown in FIG. 1, the ODSS 200 illustrated in FIG. 2 comprises a plurality of storage components 116, which are accessible for a consumer 104 via a consumer data interface 120. The ODSS 200 further comprises a provider interface 122 for communication with the provider 110.

The functionality of the ODSS 200, described above as the main aspects of the present invention, is provided by a separate consumer SLO interface 202, an ODSS management instance 204, an ODSS repository 206 and a component discovery and classification (CDC) component 208.

According to the concept of the ODSS 200 the consumer 104 defines data classes and assigns SLOs to these data classes, thus forming SLO policies 210. The data classes can be derived from applications the consumer is using. For example, the consumer may be using an e-mail system defining a data class 1 with certain service levels and the consumer may be using an ERP system defining a data class 2 with certain service levels. Thus, the data classes can be derived from the different applications. Alternatively, there can be multiple data classes for one application, for example a data based application may have one data class for the recovery logs and one data class for the actual data. Associated service levels are determined by the consumer and entered into subject application or a separate application via a user interface.

These SLO policies 210 are transmitted to the ODSS 200 via the consumer SLO interface 202 and are automatically managed by the ODSS management instance 204.

The data 106 from the consumer 104 is transmitted to the ODSS 200 via the consumer data interface 120. The transmission of data occurs according to prior art methods and protocol such as the SCSI protocol, the fiber channel protocol or the Infiniband protocol. The ODSS 200, more precise the ODSS management instance 204 ensures that the data 106 is stored on an appropriate storage component 116 satisfying the SLOs. The provider 110 ensures that the ODSS 200 is working properly via the provider interface 122 and provides the necessary storage components 116 in order to satisfy the SLO policies.

It should be mentioned here, that the word instance is used in association with the ODSS because an ODSS may manage multiple instances, one for each consumer or one for each consumer SLO policy. The ODSS management instance 204 automatically maps the consumer SLO policies to the appropriate storage component 116 based on a component classification done by the CDC component 208. Besides, the ODSS management instance 204 automatically configures the storage component 116 according to the SLO policies and assigns the consumer data interface 120 to the consumer. Furthermore, the ODSS management instance 204 monitors the consumer data interface 120 and the storage components 116 in order to verify that the SLOs are met. If this is not the case, it derives corrective actions. Additionally, the ODSS management instance 204 performs dynamic changes to the storage components 116 upon changes of the SLO policies. Changes of the SLO policy can occur when the consumer requirements change and subsequently the consumer changes the SLOs or when the SLO-policies comprise time-dependent parameters. For example, an SLO policy may include a time period after which an SLO changes. Changing the SLO policy may also include moving the data to another storage component 116, automatically and transparent to the consumer data interface 120. Based on achieved service levels during a predefined period the ODSS management instance 204 generates reports 140. These reports 140 may include chargeback reports which may be generated based on a predefined charging model.

The CDC component 208 of the ODSS 200 basically discovers storage components 116 available to the ODSS 200 and classifies them according to service levels provided by these storage components 116. Then, the discovered storage components 116 together with the associated SLOs provided by such storage components 116 are stored in the ODSS Repository 206 as Component-Service Level Catalogue (CSLC). Besides, the CDC component 208 includes methods for a policy-based activation of component discovery. These policies can be selected by the provider 110 and can be given different priorities. Such policies for activation of discovery are for example upon SLO breaches or automatically when new storage components are added to an ODSS. The discovery can also be manually triggered by the provider.

The ODSS repository 206 is used to store the metadata associated with an ODSS system. Metadata includes, but is not limited to the following data:

SLO Policies 210 (SLO-Data Mapping) provided from consumer

SLO—Component mapping which maps the SLOs comprised in SLO-policies to storage components

Storage component related information such as service levels provided by a storage component, its capacity and technical specification

SLO Measurement results

Audit data provided by all ODSS management instances

Charging model created by the provider

Chargeback reports

Storage component—Service Level Catalogue provided by CDC component 208 (CSLC: Storage Component—SLO mapping).

The ODSS architecture 200 shown in FIG. 2 enables the following novel automated methods provided by the main ODSS components ODSS management instance 204, ODSS repository 206, CDC module 208 and consumer SLO interface 202:

Automated storage component discovery and classification

Automated mapping of consumer SLO policies 210 to storage components 116

Automated configuration of storage components 116 based on the mapping of consumer SLO policies 210 to storage components

Automated monitoring, metering and comparison of configured SLOs to actual SLOs and subsequent provider notification and adjustment of data placement and management based on SLO breaches

Lifecycle Management based on SLO changes

Automated generation of chargeback reports based on charging models, e.g., to charge for how much data received which kinds of service levels for what period of time

Just-in-Time capacity provisioning based on historic data and policies.

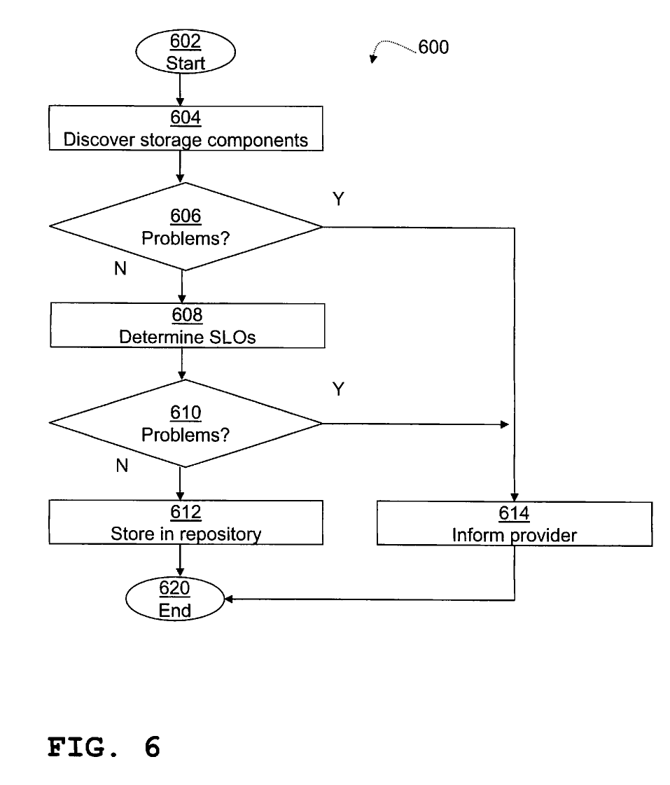

The flowchart of FIG. 6 illustrates a process 600 for automated storage component discovery and classification which is executed by the CDC component 208 of the ODSS 200 shown in FIG. 2.

Process 600 starts in step 602. There are various possibilities to initiate the automated discovery and classification of storage components. For better understanding they will be discussed after having explained the whole process 600.

In step 604 storage components 116 available to the ODSS 200 are discovered. The discovery of storage components is based on prior art and can happen in-band or out-of band. A typical in-band discovery can be based on the SCSI Inquiry command. A typical out-band discovery can be based on a management interface and protocol such as SMI-S.

In step 606 it is determined whether there were problems to discover such storage components. If the answer in step 606 is yes then the process flows to step 614, where a message is sent to the provider informing him about said problem. This message might be sent via e-mail, SNMP or other reporting protocols according to prior art. Consequently, the provider may repair problems in discovering storage components.

If the answer in step 606 is no the process flows to step 608 where for each discovered storage component the associated SLOs are determined. This mapping is often based on a classification of the discovered storage components according to their type of technology such as disk, tape and optical. Under each type, there can be subtypes such as:

Type Disk:

Fiber Channel disk

Mirrored disk

RAID protected disk

SATA

Mirrored disk

RAID protected disk

Disk File System or network attached storage

Mirrored disk

RAID protected disk

Type Tape:

Short tape

WORM tape

Encryption Tape

Long tape

WORM tape

Encryption Tape

Type optical

UDO

WORM protected

Blue Ray

WORM protected

It should be mentioned here that the number of types and subtypes is not limited by this invention. Then, the mapping of SLOs to the discovered storage components can be based on a predefined mapping of storage component device type to SLOs e.g., a disk has an initial access time of <1 second.

In an alternate embodiment the determination of the SLOs is based on actual tests executed in this step. For example the CDC component 208 may store test data on a discovered storage component 116 and measure the SLO initial access time and the SLO throughput. However, not all SLOs can be tested this way.

The mapping of storage components can also be based on reporting capabilities of an individual storage component in case that the storage component is able to report the SLOs it can achieve. This reporting can be done via the provider or data interface and via the storage component interface according to prior art. For example a fiber channel disk system can report some SLOs via the SCSI LOG Sense command or via SMI-S protocol (SNIA's Storage Management Initiative-Specification).

In step 610 the determination is made if there were problems to determine the SLOs for discovered storage components. If the answer in step 610 is yes then the process flows to step 614, where a message is sent to the provider informing him about said problem. Again, said message might be sent via e-mail, SNMP or other reporting protocols according to prior art. Consequently, the provider may also repair problems in determining SLOs for discovered storage components. From step 614 the process flow to the ending step 620.

If the answer in step 610 is no the process flows to step 612 where the mapping of discovered storage components (step 604) to the SLOs (step 608) is stored in the ODSS repository 206 as Component-Service Level Catalogue (CSLC). This CSLC is used by other ODSS management components, what is explained in connection with FIGS. 2 and 3 to 5. Table 1 shows an exemplary entry of an CSLC:

TABLE 1
Example for storage components to SLO mapping (CSLC)

| Compo- | | | | |
|---|---|---|---|---|
| nent | Component | Date | | Maximum |
| Number | Type | Interface | SLO | capacity |
| 1 | Disk: | NFS/ | Access Time < 1 sec | 100 TB |
| | Disk File | CIFS | Throughput < 30 MB/sec | |
| | System: | | RTO = 4 hours | |
| | mirrored | | | |
| 2 | Disk: | Fiber | Access Time < 1 sec | 200 TB |
| | Fiber | Channel | Throughput ~80 MB/sec | |
| | Channel: | | RTO < 2 hours | |
| | mirrored | | RPO < 10 | |
| | | | minutes | |

The second row in Table 1 contains an exemplary entry generated by the CDC component 208. Each storage component has a number in order to allow its unique identification (column “component number”). The first entry specifies a mirrored disk file system (column “component type”) providing an NFS/CIFS based data interface (column “Data Interface”) and the SLOs provided by that component are given in the last column (column SLO). There might also be more SLOs associated with that storage component. The third row in Table 1 contains another exemplary entry generated by the CDC component. Therewith, a mirrored fiber channel disk system (column “component type”) is specified providing a fiber channel based data interface (column “Data Interface”). The SLOs provided by that storage component 2 are given in the last column (column SLO). To go without saying there may be more entries in that mapping Table 2. Also, the mapping of storage components and SLOs may include all possible configurations of storage components and SLOs. For example a file system can be configured with different RPO dependent on the number of copies and the copy mode. Associated configuration specific details are included in this mapping.

As mentioned above, in step 614 a notification is posted to the provider in case that the automated assigning of SLOs to storage components is not possible for all discovered storage components. In this context it should be mentioned, that the CDC component 208 also offers the possibility to update the CSLC manually.

Process 600 described above is initiated in step 602. In a first embodiment of the present invention this can be done manually by the provider. In another advantageous embodiment the CDC component triggers process 600 on a regular base in the background. This way the CSLC is updated periodically. The CDC component 208 may also include methods for a policy-based activation of component discovery and classification. These policies may comprise different methods which can be selected by the provider and which can be prioritized. One method triggers process 600 whenever an SLO breach has been detected by the ODSS management instance 204. Another method triggers process 600 whenever new storage components have been added to the ODSS and/or whenever storage components of the ODSS have been removed or changed. Yet another method triggers process 600 after repair action or firmware updates for storage components comprised in the ODSS.

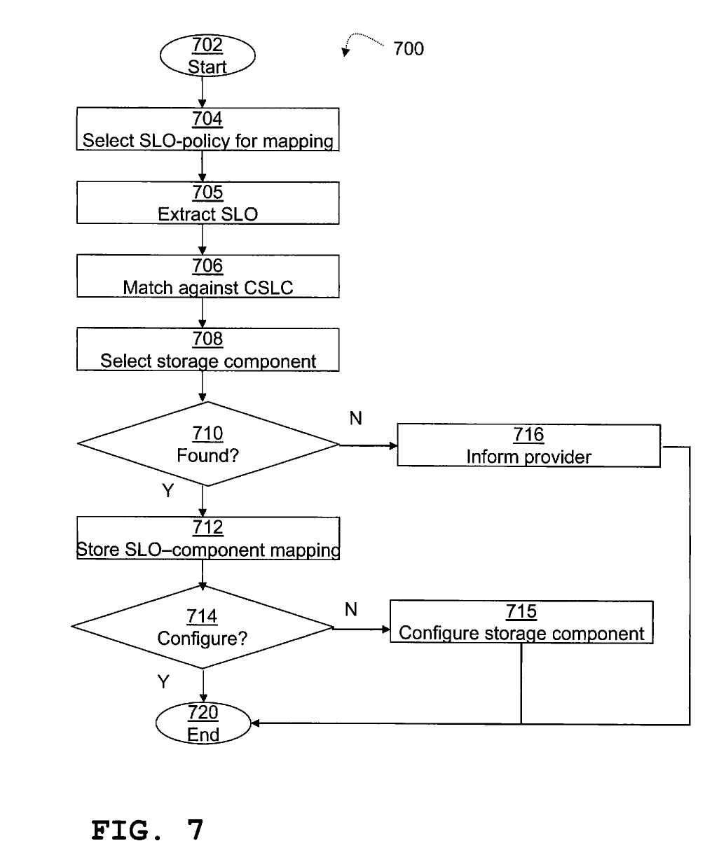

The automated mapping of consumer SLO policies 210 to storage components 116 and the corresponding configuration of said storage components are aspects of the present invention which are best understood referring again to FIG. 2 and later to FIG. 7.

The consumer defines SLO policies 210 wherein each policy comprises a unique data class and the associated service levels required by the consumer. The SLO policy 210 is passed from the consumer computing system 104 to the ODSS 200 via a consumer SLO interface 202. That interface 202 can be based on Ethernet and the TCPIP protocol. This interface 202 may implement a protocol allowing exchange of SLO policies 210 based on the SLO policy structure. The ODSS 200 checks whether the requested SLO policy can be provided by the system. Therefore, it compares the requested SLOs with the SLOs provided using the Component-Service-Level-Catalogue (CSLC). If the SLOs requested by the consumer cannot be satisfied then the ODSS 200 informs the consumer about this via the interface 202 utilizing the associated protocol.

The SLO policy structure is exemplarily presented in Table 2, especially by the columns of Table 2:

TABLE 2
Exemplary SLO policies

| SLO | Unique | | | |
|---|---|---|---|---|
| policy | Data | Data | | Capacity per |
| number | Class | Interface | Service Level | time period |
| 1 | E-Mail | NFS via | Access time < 1 sec | 100 GB/ |
| | | Ethernet | Throughput = 20 MB/sec | year |
| | | (mount | RTO < 4 hours | |
| | | point/e-mail) | | |
| 2 | E-Mail | NFS via | Access time after 1 | 100 GB/year |
| | | Ethernet | year < 30 sec | |

The first column of Table 2 is dedicated for an SLO policy number representing a unique identification for each SLO policy. The second column indicates the unique data class of the corresponding SLO policy and the third column lists the data interface for that data specifying the protocol and interface type. In the fourth column the service levels are listed which have to be met for that data class. And the fifth column lists the capacity required in a certain time period. Each row of Table 2 represents one SLO policy. It is understood that there may be multiple SLO policies for one data class.

In the example of Table 2, the data class e-mail must meet the following service levels: initial access time <1 seconds, throughput >=20 MB/sec, recovery time objective <4 hours. This policy (number 1 in Table 2) requires 100 GB per year of capacity and must be accessible via NFS with a mount point of /e-mail). In the third row another SLO policy for data class e-mail is listed and specifies that the access time can be <30 seconds when the e-mail is 1 year or older.

As the SLO policies 210 are transmitted to the ODSS 200 via the consumer SLO interface 202 and stored in the ODSS repository 206 the ODSS management instance 204 is able to map this SLO policies 210 to storage components 116 which have previously been discovered and classified by the CDC component 208. Therefore the SLO policies are compared with the information given by the CSLC.

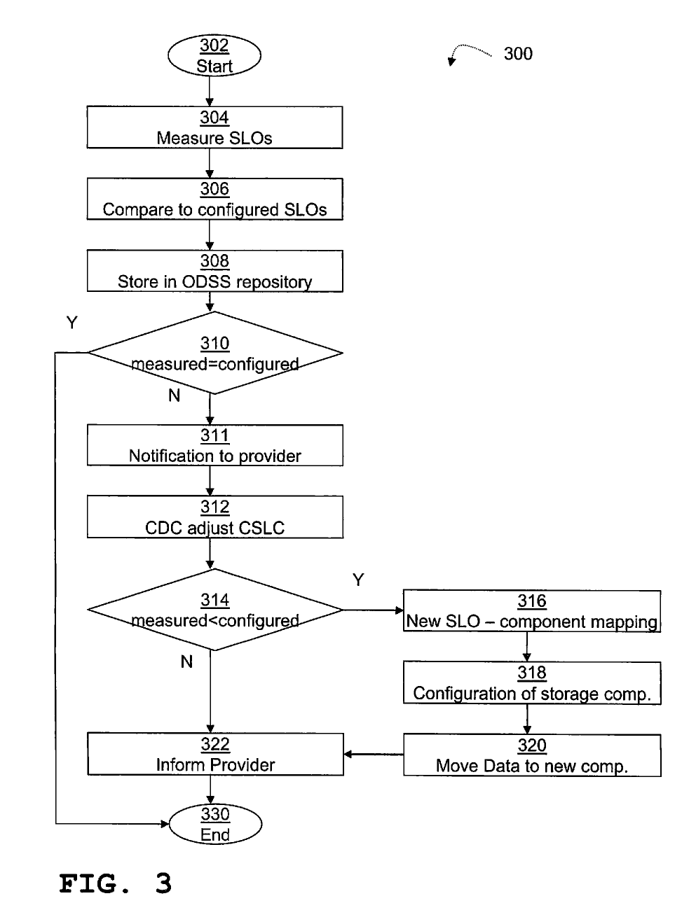

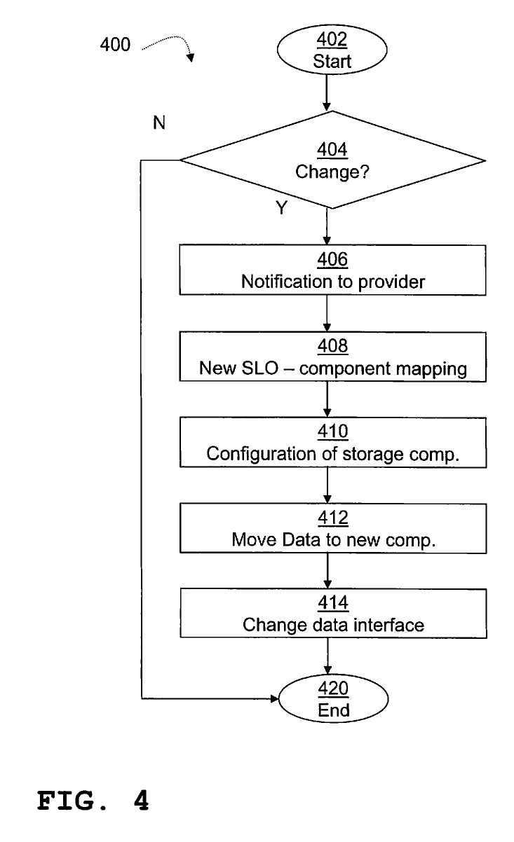

The automated mapping of SLO-policies to storage components is further described in process 700 of FIG. 7. Process 700 starts in step 702. The start of process 700 is triggered when an SLO-policy is received via the SLO interface 202. Process 700 may also be triggered by processes 300 of FIGS. 3 and 400 of FIG. 4.

In step 704 the SLO policy to be mapped against a storage component is selected from the ODSS repository 206. Selected SLO-policy includes one or more SLOs. For example SLO-policy number 1 according to Table 2 may be selected.

In step 705 the SLOs comprised in SLO-policy are extracted. For example the SLOs for SLO-policy number 1 of Table 2 are: access time <1 sec; throughput=20 MB/sec and RTO <4 hours.

In step 706 the SLOs extracted in step 705 are matched against the Component-Service-Level-Catalogue which has been created by the component discovery component 208 and stored in ODDS repository 206. Thereby all SLOs pertaining to selected SLO-policy must match the SLOs provided by a storage component according to Table 1. For example the SLOs pertaining to SLO-policy number 1 of Table 2 are matched against the SLOs of the storage component number 1 of Table 1.

In step 708 the storage component is selected where the SLOs, the data interface and capacity match between the SLO-policy (Table 1) and storage component SLO (Table 2).

In step 710 it is checked if a storage component was selected in step 708. If the answer is no the process flows to step 716 where a notification is sent to the provider. Then, the provider has the possibility to manually map the SLO policy to a storage component, or the provider can install additional storage components to meet such SLO policies. The notification to the provider is done via provider interface 122 and can for example be based on e-mail, SNMP traps or SMI-S specific messages. From step 716 the process flows to the ending step 720.

If the answer in step 710 is yes indicating that a storage component matching the SLOs for the SLO-policy selected in step 704 has been found the process flows to step 712.

In step 712 the process stores the mapping of SLO-policy to storage component in the ODSS repository as SLO—Component mapping.

In step 714 the decision is made whether the selected storage component is to be automatically configured. If the answer in step 714 is yes then the process flows to step 715 where the configuration of the selected storage component is done. The configuration of a storage component is usually done through a management interface of said storage component such as a command line interface allowing automation. The ODSS management instance has knowledge of the management interface and the associated protocol. For example the component number 1 of Table 1 is being configured with a NFS file system with mount point /email and 100 GB capacity. In addition mirroring of this system is configured to assure a RTO <4 hours. In a preferred embodiment of the present invention also the mount point (/email) is mounted automatically at the consumer data interface 120 by the ODSS management instance 204, i.e., by executing remote commands (rexec) at the consumer computing system. In an alternate embodiment the ODSS management instance 204 informs the provider 110 via provider interface 122 about the completion of the configuration and provides details about the mount point. From step 715 the process flows to ending step 720.

If the answer in step 714 is no the process flows to the ending step. This may be the case when process 700 is invoked by processes 300 and 400 which are explained later. In the ending step the mapping of the SLO-policy to a storage component has been completed.

The flowchart of FIG. 3 illustrates a process 300 for automated monitoring, metering and comparison of configured SLOs to actual SLOs. Besides, this process 300 comprises subsequent provider notification and adjustment of data placement and management based on SLO breaches.

Process 300 is provided by the ODSS management instance 204 of the ODSS 200 shown in FIG. 2. It starts in step 302 for a particular SLO policy or set of SLO policies. As explained above in connection with Table 2, each SLO policy is denoted by the data class, interface, service level objectives (SLOs) and capacity. These parameters are stored in the ODSS repository 206. The invocation of process 300 is configurable for each SLO policy or sets of SLO policies, e.g., for all SLO policies with identical data class. In a preferred embodiment of the present invention process 300 is invoked periodically, for example every minute, hour, day, week or month.

After invocation process 300 continues to step 304 where the actual SLOs are measured. The SLOs to be measured—part of the SLO-policy—are obtained from the ODSS repository 206, where the consumer SLO policies are stored. The measurement of actual SLOs is based on prior art methods such as reporting via SMI-S or prior art measurement tools, such as topas or nmon available for UNIX systems or measurement tools provided by prior art storage systems. The measurement may be done at the storage component 116 or at the consumer data interface 120. The measurement in step 304 produces tangible results.

From step 304 the process flows to step 306 where the SLO measurements of step 304 are compared to the SLOs configured with the consumer SLO policies. These are obtained from the ODSS repository 206.

In step 308 the measured SLOs and the result of the comparison of step 306 are stored in the ODSS repository 206 for reporting and chargeback purposes.

In step 310 the process determines whether the measured SLOs are equal to the configured SLOs. The comparison of the measured and configured SLOs may take into account some tolerances which are user-configurable and which are stored in the ODSS repository 206 as part of an SLO policy.

If the answer in step 310 is yes the process proceeds to the ending step 330 indicating that there was no SLO breach.

Otherwise, if the answer in step 310 is no the process flows to step 311 to further process the SLO breach detected. In step 311 the process notifies the provider about the SLO breach. The notification to the provider is done via provider interface 122 and can for example be based on e-mail, SNMP traps or SMI-S specific messages.

In step 312 the process informs the CDC component 208 about the SLO breach. The CDC component 208 updates the Component-Service Level Catalogue (CSLC) with the new SLO values measured in step 304.

In step 314 the process checks if the measured SLOs are smaller or worse than the configured SLOs. If the answer is yes the process flows to step 316 because immediate corrective action is required in order to achieve service level agreements (SLA). If the answer is no the process flows to step 322 explained later.

In step 316 the ODSS management instance 204 performs a new mapping of consumer SLO policies 210 to storage components 116 according to process 700 of FIG. 7. Thereby no configuration of the new selected storage component may be done in process 700. And in step 318 the ODSS management instance 204 configures the storage components 116 based on said new mapping of consumer SLO policies 210 to storage components 116 resulting from step 316.

In step 320 all data which was stored on the storage components failing to deliver the required SLOs is moved to the newly configured storage components. Thereby, the data might be copied from one storage device to another using prior art methods such as the copy command or logical volume mirroring. From step 320 the process flows to step 322.

In step 322 the provider is informed that there was an SLO breach detected including the measured and configured values. If the SLO breach was positive meaning that the measured values are greater than the configured values pertaining to an SLO the provider may get an extra notification. This is because the ODSS 200 delivers more than the customer expected. The provider may use this fact to inform the consumer about the improvements of the SLOs and ask if the customer wants to maintain these SLOs. If the consumer agrees to this then the according SLO policy must be adjusted with the newly measured values for the SLOs and stored in the ODSS repository 206. From step 322 the process flow to ending step 330.

In ending step 330 the consumer data interface 120 is configured to use the new storage components which have been configured in step 318. The process 300 ends here.

The flowchart of FIG. 4 illustrates a process 400 for automated Lifecycle management based on SLO changes which may be provided by a preferred embodiment of the present invention.

Service levels (SLOs) may change over time as requested by the consumer through SLO policies 210 communicated via consumer SLO interface 202. For example Table 2 includes two SLO policies for e-mail data. The first policy applies to the initial storage of e-mails, the second policy is a lifecycle policy for e-mail data and indicates that the access time to e-mail data which is more than 1 year old can be up to 30 seconds.

Therefore, a method is provided determining when an SLO policy changes over time and applying that change to the ODSS system 200. This method is also provided by the ODSS management instance 204. This method is further explained in connection with process 400 illustrated in FIG. 4.

Process 400 starts in step 402 for a particular SLO policy or set of SLO policies. As explained above in connection with Table 2, each SLO policy is denoted by the data class, interface, service level objectives (SLOs) and capacity. These parameters are stored in the ODSS repository 206. The invocation of process 400 is configurable for each SLO policy or set of SLO policies, e.g., for all SLO policies with identical data class. In a preferred embodiment of the present invention process 400 is invoked periodically, for example every minute, hour, day, week or month.

After invocation process 400 continues to step 404 where the determination is made whether an SLO has to be changed. For example in Table 2 the SLO “access time” has to be changed after one year to allow data access within 30 seconds. So in step 404 the process 400 compares if any data pertaining to a SLO-policy is stored one year or longer. If the decision in step 404 is no the process flows to the ending step 420. Otherwise, if the decision in step 404 is yes the process flows to step 406. For example—according to Table 2—the decision is yes if one year has passed after the e-mail data has been stored in ODSS system 200.

In step 406 the process notifies the provider about the change of SLOs. The notification to the provider is done via provider interface 122 and can for example be based on e-mail, SNMP traps or SMI-S specific messages.

In step 408 the ODSS instance 204 performs a new mapping of consumer SLO policies 210 to storage components 116 according to process 700 of FIG. 7. Thereby no automated configuration of the selected storage component may be done in process 700 (step 715 may be omitted). And in step 410 the ODSS instance 204 configures the storage components 116 based on said new mapping of consumer SLO policies 210 to storage components resulting from step 408.

In step 412 all data which was stored on the old storage components is moved to the new storage components configured in step 410. Thereby the data might be copied from one storage device to another using prior art methods such as the copy command or logical volume mirroring.

In step 414 the consumer data interface 120 is configured to use the new storage components which have been configured in step 410. The process 400 ends in step 420.

The automated generation of chargeback reports based on charging models is another aspect of the present invention which may be provided by the ODSS 200 shown in FIG. 2.

Chargeback reports are used by the provider 110 to charge the consumer 104 for the service levels actually provided over a predefined period of time representing the billing cycle. Besides, chargeback reports take into account that different service levels are associated with different costs. Usually, the calculation of the costs to be charged is based on a charging-model created by the provider 110 and stored in the ODSS repository 206. So, the ODSS instance management component 204 is able to use the provider's charging-model and the measured actually provided service levels to create the chargeback reports. The actually provided service levels are measured periodically, e.g., by applying process 300, and stored in the ODSS repository 206. For a chargeback report only the data relevant for the billing period is retrieved from the ODSS repository 206. The chargeback reports may also be stored in the ODSS repository 206.

The following charging models are examples for calculating the total cost K:

Capacity based: Total cost K is proportional to the used capacity C in a given billing cycle. The proportion factor constant k_{c} is defined in the charging model (k_{c} is expressed in a currency such as Euro)

K=C*k_{c} (eqn 1)

Configured SLO-and-Capacity based: Total cost K is based on the service levels which have been configured in association with the used capacity during a given billing cycle. Each configured service level Sᵢ is defined by a cost factor kcᵢ which is stored in the charging model (kcᵢ is expressed in a currency such as Euro)

K=C*(sum kcᵢ) (eqn. 2)

Achieved SLO-and-Capacity based: Total cost K is based on the service levels which have been achieved in association with the used capacity during a given billing cycle. Each achieved service level Sᵢ is defined by a cost factor kaᵢ which is stored in the charging model (kaᵢ is expressed in a currency such as Euro)

K=C*(sum kaᵢ) (eqn. 3)

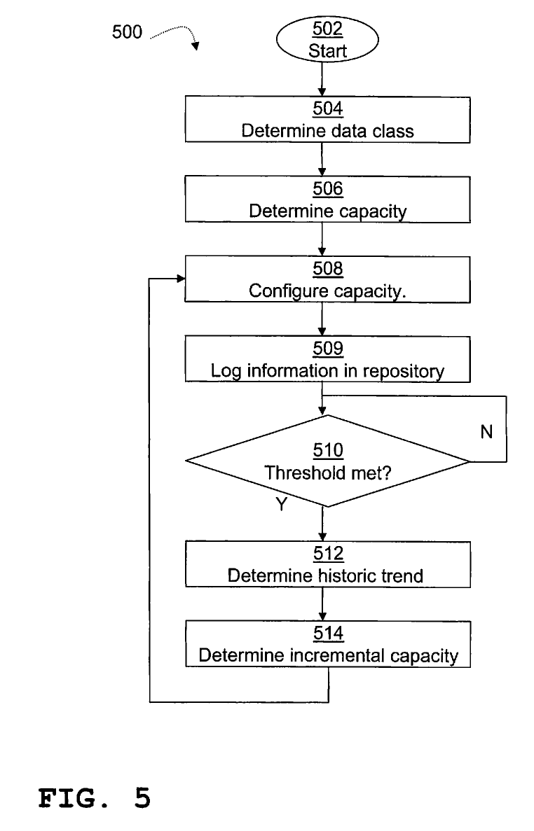

The flowchart of FIG. 5 illustrates a process 500 for automated Just-in-Time capacity provisioning based on historic data and policies which may be provided by a preferred embodiment of the present invention.

Just-in-time capacity provisioning means that the ODSS system 200 provides some initial capacity based on the data class of a consumer SLO policy and increases the provided capacity when a certain threshold is met or when the historical data indicates that more storage capacity is required in the near future (trend-analysis). In the here described embodiment the amount of increase is based on increments which are calculated based on the actual trend. The advantage is that no storage capacity provided by storage components 116 is wasted. Since the data class is part of an SLO policy 210 which the consumer 104 passes through the consumer SLO interface 202 the ODSS system 200 and more precise the ODSS management instance 204 knows the class of data. For each data class the provider predefines the initial capacity to be provided.

Process 500 starts in step 502 where the ODSS management instance 204 receives a request to provide initial capacity for a certain class of data which is associated to the SLO policy 210. This request might be triggered by any process automatically configuring storage components such as step 318 of process 300 in FIG. 3, step 410 of process 400 in FIG. 4 and step 715 of process 700 in FIG. 7.

In step 504 the process determines the data class which is part of the SLO policy 210. In step 506 the process determines the initial capacity provided for said data class. The initial capacity is preconfigured and stored in the ODSS repository 206. And in step 508 the capacity determined in step 506 is configured at the storage component.

In step 509 the information about the amount of configured capacity and the date and time is stored in the ODSS repository 206. This information is used by the trend analysis in step 512.

In step 510 the decision is made whether the capacity is filled by more than a high-threshold. Such high-threshold might be configured by the user to 80%. If the answer in step 510 is no the process returns to step 510 indicating that it is a repetitive process. Otherwise if the answer in step 510 is yes the process flows to step 512.

In step 512 the actual trend is determined. Determining the actual trend includes to review the last capacity increments and the capacity usage within these increments over time which are logged by step 509 in the ODSS repository 206. The analysis includes the determination of the date and time and the amount of incremented capacity.

In step 514 the process determines the amount of capacity to be incremented based on the historical information determined in step 512. This determination is based on prior art processes such as the mean of the last three capacity increments plus 20%. From step 514 the process flows back to step 508 where the capacity determined in step 514 is configured. Note, the capacity determined in step 514 can also be zero indicating that no extra capacity must be configured.

Steps 508 to 514 of process 500 can be integrated with process 300 shown in FIG. 4 where a periodic SLO-measurement is performed. Said steps can be performed within step 304 of process 300.

It should be pointed out, that Just-in-time capacity provision as described above is different from thin provisioning according to prior art. Thin provisioning means that the capacity needed at a certain point of time is provisioned and configured during data transfer. Just-in-time provisioning according to this invention is not executed during data transfer but as a separate process and it takes historical information into account to configure appropriate capacity increments.

What is claimed is:

1. A method for automatically managing a storage infrastructure, wherein at least one consumer data interface, and at least one provider interface; which is provided and managed by a provider and used by at least one consumer and which comprises
storing consumer data under consideration of consumer specified SLO policies, which are consumer specified service level objectives (SLOs) for consumer specified data classes, said method comprising:
identifying available storage components, which are appropriate for storing consumer data under consideration of specified service level objectives (SLOs);
mapping of said consumer SLO policies to said available storage components to select available storage components for specified data classes; and
configuring said selected storage components according to said mapping of consumer SLO policies.

2. The method according to claim 1, wherein each identified available storage component is characterized by a parameter set, at least comprising
a unique storage component identification,
the type of technology,
at least one possible SLO,
the type of data interface and
the maximum capacity;
and wherein each consumer SLO policy is characterized by a parameter set, at least comprising
a unique SLO policy identification,
a unique data class,
a type of data interface,
at least one SLO, and
the capacity per time period.

3. The method according to claim 1, wherein the actual SLOs of at least one particular SLO policy are measured and compared to the configured SLOs of said particular SLO policy to detect SIO breaches.

4. The method according to claim 3, wherein the provider is notified about negative SLO breaches as well as about positive SIO breaches.

5. The method according to claims 2, wherein the parameter set of the storage component being responsible for an SLO breach is updated with the measured storage component parameters.

6. The method according to claim 5, wherein in case of a negative SLO breach:
mapping of said particular SLO policy to available storage components is performed to select an appropriate available storage component for the data class specified with said particular SLO policy;
configuring of said selected storage component is performed, consequently; and
performing a data transfer to the newly selected and configured storage component.

7. The method according to claim 5, wherein in case of a positive SLO breach:
performing an adjustment of said particular SLO policy by updating the corresponding parameter set according to the measured SLOs.

8. The method according to claim 1, wherein at least one of the consumer specified SLO policies is dependent on time.

9. The method according to claim 8, wherein whenever changes of SLO policies are detected mapping of said SLO policies to available storage components and configuring of said selected storage components is performed.

10. The method according to claim 9, wherein, in case that data already stored shall be kept according to a changed SLO policy, said data is transferred to an appropriate newly selected and configured storage component.

11. The method according to claim 8, wherein whenever changes of SLO policies are detected the provider is notified about said changes.

12. The method according to claim 1, wherein information about the extent of storage service effectively demanded by a consumer is provided and stored as consumer specific chargeback information in a metadata repository.

13. The method according to claim 12, wherein said consumer specific chargeback information comprises:
the service levels provided over a given period of time,
the storage capacity used in a given period of time,
the service levels configured in association with the used storage capacity during a given period of time, and/or
the service levels achieved in association with the used storage capacity during a given period of time.

14. The method according to claim 1, wherein an initial storage capacity is defined for the data class of at least one SLO policy and wherein the storage component selected for said data class is configured to provide said initial storage capacity.

15. The method according to claim 14, wherein the actual utilization of the so configured storage component is observed to increase the actual storage capacity, if necessary.

16. The method according to claim 15, wherein the changes of said actual utilization are observed over a given time period to determine the amount of capacity increase.

17. A storage infrastructure which is provided and managed by a provider and used by at least one consumer, said storage infrastructure comprising
storage components for storing consumer data under consideration of consumer specified SLO policies, which are consumer specified service level objectives (SLOs) for consumer specified data classes,
at least one consumer data interface, and
at least one provider interface;
said storage infrastructure being characterized by at least one management instance, which automatically ensures that consumer data is stored on appropriate storage components satisfying the corresponding SLO policies;
by at least one consumer service level interface for providing SLO policies to said management instance,
by a component discovery and classification module for identifying available storage components appropriate for storing consumer data according to specified SLOs,
and by at least one repository for storing metadata associated with the storing of consumer data under consideration of SLO policies.

18. A system to automatically manage service levels across a plurality of storage components on the base of SLO policies, which are consumer specified service level objectives (SLOs) for consumer specified data classes, said system comprising:
an ODSS management instance, which automatically ensures that consumer data is stored on appropriate storage components satisfying the corresponding SLO policies;
an ODSS repository for storing metadata associated with the storing of consumer data under consideration of SLO policies;
an ODSS component discovery and classification module for identifying available storage components appropriate for storing consumer data according to specified SLOs;
a consumer service level interface for providing SLO policies to said ODSS management instance.

19. A computer program product stored on a computer usable medium, comprising computer readable program means for causing a computer system to perform a method according to claim 16.
